(19) United States
(12) Patent Application Publication
(10) Pub. No.: US 2026/0352085 A1
(43) Pub. Date: Nov. 5, 2026

(54) Method for Discharging Middle Switches of a 3-Level Inverter

(71) Applicant: Bayerische Motoren Werke Aktiengesellschaft, Muenchen (DE)

(72) Inventors: Florian BUETTNER, Pfakofen (DE); Joerg REUSS, Unterschleissheim (DE)

(21) Appl. No.: 19/101,816

(22) PCT Filed: Jul. 12, 2023
(86) PCT No.: PCT/EP2023/069324

§ 371 Date: Feb. 6, 2025

(30) Foreign Application Priority Data
Aug. 9, 2022 (DE) 10 2022 119 970.3

(51) Int. Cl. H02M 1/00; B60L 50/51; B60L 50/60; H02M 7/487; H02M 7/5387

(52) U.S. Cl. CPC H02M 1/0058; B60L 50/51; B60L 50/60; H02M 7/487; H02M 7/53871; B60L 2210/42

(57) ABSTRACT

A method for operating a 3-level inverter to reduce conduction losses of neutral point switching apparatuses. The method includes predetermining a switching pattern in a conduction-loss-reducing variant in which at least one voltage vector of the switching pattern, which is produced by a switching state with at least one neutral point switching apparatus involved, is at least partially replaced by two voltage vectors that are produced by switching states without the neutral point switching apparatuses involved.

### BACKGROUND AND SUMMARY

The invention relates to a method for operating a 3-level inverter that has an intermediate circuit comprising three connections in the form of a high-side connection, a low-side connection and a neutral point connection and at least three switching sections that are connected to the intermediate circuit and each comprise a phase tap for electrical connection to a respective phase of an electrical drive machine. Each switching section in each case has three switching apparatuses in the form of a high-side switching apparatus that is connected to the high-side connection, a low-side switching apparatus that is connected to the low-side connection, and a neutral point switching apparatus that is connected to the neutral point connection. A switching pattern for the switching apparatuses is determined in order to modulate an operating-point-specific output voltage, by way of which switching pattern the switching apparatuses are transferred to different switching states and in so doing connect the phase tap of the respective switching section to a respective one of the connections of the intermediate circuit, generating a voltage vector. The invention furthermore relates to a control apparatus, a power module and a motor vehicle.

In the present case, the focus is on 3-level inverters for electrically driveable motor vehicles, that is to say electric or hybrid vehicles. Such 3-level inverters are connected between an electrical energy storage unit, for example a traction battery, and an electrical drive machine of the motor vehicle, and are used to convert a DC voltage provided by the electrical energy storage unit into a polyphase AC voltage for phases of the electrical drive machine. The 3-level inverter may also be used as a power factor correction filter for a 3-phase charging device.

Inverters usually have three half-bridges connected in parallel and an intermediate circuit connected to the half-bridges. Each half-bridge respectively has two switching apparatuses, wherein a first switching apparatus is in the form of a high-side switching apparatus and is connected to a high-side connection of the intermediate circuit, and wherein a second switching apparatus is in the form of a low-side switching apparatus and is connected to a low-side connection of the intermediate circuit. In addition to the half-bridges, 3-level inverters have three third switching apparatuses that are in the form of neutral point switching apparatuses and are in each case electrically connected to a tap between the first and the second switching apparatus of a half-bridge and to a neutral point connection of the intermediate circuit. Such a 3-level inverter may provide three voltage levels for the phases of the electrical machine for each switching section that consists of a half-bridge and a neutral point switching apparatus, and therefore has, in addition to the eight switching states of a conventional 2-level inverter, 19 further switching states to modulate an operating-point-specific output voltage. These 27 switching states may be used to produce a desired sinusoidal shape of the output voltage with a particularly low proportion of harmonics, as a result of which losses in the electrical machine are reduced. Furthermore, the 3-level inverter has particularly low switching losses.

In order to reduce the costs of the 3-level inverter, the quality and the quantity of neutral point switches of the neutral point switching apparatuses may be reduced, for example. This reduction of the neutral point switches increases the conduction losses at certain operating points of the 3-level inverter. On account of the thermal boundary condition, these conduction losses reduce the efficiency of the system and may furthermore lead to overloading of the neutral point switches.

It is the object of the present invention to provide a solution for reducing average conduction losses, which occur over a modulation period, of neutral point switches of a 3-level inverter for a motor vehicle.

This object is achieved according to the invention by means of a method, a control apparatus, a power electronics module and a motor vehicle having the features according to the respective independent patent claims. The dependent patent claims, the description and the figures relate to advantageous embodiments of the invention.

A method according to the invention is used to operate a 3-level inverter. The 3-level inverter has an intermediate circuit comprising three connections in the form of a high-side connection, a low-side connection and a neutral point connection. Furthermore, the 3-level inverter has at least three switching sections that are connected to the intermediate circuit and each comprise a phase tap for electrical connection to a respective phase of an electrical drive machine. Each switching section in each case has three switching apparatuses in the form of a high-side switching apparatus that is connected to the high-side connection, a low-side switching apparatus that is connected to the low-side connection, and a neutral point switching apparatus that is connected to the neutral point connection. A switching pattern for the switching apparatuses is determined in order to modulate an operating-point-specific output voltage, by way of which switching pattern the switching apparatuses are transferred to different switching states and in so doing connect the phase tap of the respective switching section to a respective one of the connections of the intermediate circuit, generating a voltage vector.

In order to reduce conduction losses of the neutral point switching apparatuses, the switching pattern is determined in a conduction-loss-reducing variant in which at least one voltage vector of the switching pattern, which is produced by a switching state with at least one neutral point switching apparatus being involved, is at least partially replaced by two voltage vectors that are produced by switching states without the neutral point switching apparatuses being involved.

The invention furthermore includes a control apparatus, which is configured to carry out a method according to the invention, and a power electronics module comprising a 3-level inverter and a control apparatus according to the invention. A motor vehicle according to the invention comprises an electrical energy storage unit, an electrical machine and a power electronics module according to the invention, wherein the 3-level inverter is connected on the input side to the electrical energy storage unit and on the output side to phases of a stator of the electrical machine. The 3-level inverter is configured to convert the DC voltage, which is provided by the electrical energy storage unit and is present as input voltage at the intermediate circuit of the 3-level inverter, into a polyphase AC voltage, and to provide same as output voltage for the phases of the electrical machine.

On the input side, the 3-level inverter has the intermediate circuit that in particular has at least one series circuit comprising at least two capacitors. The switching sections or switching bridges each have the high-side switching apparatus comprising at least one high-side switch, the low-side switching apparatus comprising at least one low-side switch, and the neutral point switching apparatus comprising at least one neutral point switch. The high-side switching apparatus and the low-side switching apparatus of a switching section are interconnected to form a half-bridge. Each switching section has a phase tap that is connected to the associated phase of the electrical machine. The connections of the series circuit comprising capacitors that form the high-side connection and the low-side connection of the intermediate circuit are connected to poles of the electrical energy storage unit and to the half-bridges of the switching sections. The neutral point connection, neutral point for short, that is connected to the neutral point switching apparatuses of the switching sections is provided between the capacitors of the at least one series circuit. In this case, the half-bridges each form a vertical bridge branch of the respective switching section and the neutral point switching apparatuses form a horizontal bridge branch of the respective switching section. By way of example, the high-side switches and the low-side switches may be in the form of IGBTs or power MOSFETs. In order to provide a bidirectional blocking ability, the neutral point switching apparatuses may each have two antiseries-interconnected neutral point switches or a bidirectional neutral point switch. The neutral point switches may likewise be in the form of IGBTs or power MOSFETs.

Owing to the three switching apparatuses for each switching bridge, if there are three switching bridges, the 3-level inverter has 27 switching states, wherein each switching state produces a voltage vector that is able to be represented as a space vector in a vector diagram. In this case, when a high-side switching apparatus of a switching section is closed, the phase tap of this switching section is electrically connected to the high-side connection, and a high-side potential is therefore applied to the associated phase. When a low-side switching apparatus of a switching section is closed, the phase tap of this switching section is electrically connected to the low-side connection, and a low-side potential is therefore applied to the associated phase. When a neutral point switching apparatus of a switching section is closed, the phase tap of this switching section is electrically connected to the neutral point connection, and a neutral point potential is therefore applied to the associated phase.

By way of example, three switching states, in which all the high-side switches are closed and therefore all the phase taps and phases are connected to the high-side connection of the intermediate circuit, or all the low-side switches are closed and therefore all the phase taps and phases are connected to the low-side connection of the intermediate circuit, or all the neutral point switches are closed and therefore all the phase taps and phases are connected to the neutral point connection of the intermediate circuit, produce zero voltage vectors that are represented as zero voltage space vectors in the space vector diagram. The zero voltage space vectors may therefore be produced in a redundant manner.

Six further switching states that do not have the neutral point switching apparatuses, and therefore the neutral point switches, involved produce six voltage vectors that are represented as long, outer voltage space vectors in the space vector diagram and form vertices of an outer hexagon. These six long, outer voltage space vectors correspond to the basic voltage space vectors of a 2-level inverter and are also referred to as basic voltage space vectors below. Six further switching states have the neutral point switching apparatuses involved and produce six further voltage vectors that are depicted as medium, outer voltage space vectors in the space vector diagram and are on the lateral edges of the outer hexagon between two long, outer voltage space vectors in each case.

Twelve further switching states that likewise have the neutral point switching apparatuses involved produce twelve short, inner voltage space vectors, wherein in each case two switching states provide two identical voltage space vectors, that is to say voltage space vectors with the same length and the same phase angle. Each of the short, inner voltage space vectors may therefore be produced in a redundant manner. In this case, the short, inner voltage space vectors span an inner hexagon, wherein in each case two redundant voltage space vectors form a vertex of the inner hexagon. The mutually redundant voltage space vectors have an opposite, complementary effect on a current at the neutral point connection of the intermediate circuit.

The outer hexagon is divided into six triangular sectors, wherein vertices of each sector are formed by the zero voltage space vectors and two adjacent long, outer voltage space vectors. Each sector is, in turn, divided into four triangular segments, wherein two redundant voltage space vectors are situated at at least one vertex of each segment. In order to now modulate any desired, operating-point-specific output voltage by means of the voltage vectors, the sector and the segment of the sector in which the operating-point-specific output voltage space vector representing the output voltage is situated are determined. This operating-point-specific output voltage space vector may then be produced by pulse-width modulation of the voltage space vectors spanning this segment. To this end, a switching pattern is determined, in which a sequence and a duration of the segment-specific voltage space vectors used for modulation are defined.

When the output voltage is modulated, voltage vectors that are produced by switching states with the neutral point switching apparatuses being involved and in the case of which the phase tap of at least one switching section is therefore interconnected with the neutral point connection of the intermediate circuit are also used in the switching pattern. In the case of the neutral point switches of these neutral point switching apparatuses being provided, for example for cost reasons, with a lower quality than the switches of the high-side switching apparatus and the low-side switching apparatus, these have high conduction losses in certain operating ranges. By way of example, these operating ranges are characterized by a degree of modulation and/or a modulation index and/or a degree of modulation and/or a phase current and/or a temperature of the neutral point switching apparatuses. The degree of modulation of the 3-level inverter describes the ratio between the present output voltage and the maximum possible output voltage that may be provided by the 3-level inverter. In order to reduce these conduction losses, the conduction-loss-reducing variant of the switching pattern is determined and is preferably always provided when the conduction-loss-increasing operating range of the 3-level inverter is present. Outside of this conduction-loss-increasing operating range, the voltage vectors of the switching pattern may, for example, be alternated in such a way that they are evenly loaded over the modulation period.

In the conduction-loss-reducing variant of the switching pattern, the involvement of the neutral point switching apparatuses in the switching states is reduced. To this end, at least one voltage space vector, in particular one of the zero voltage space vectors and/or one of the inner, short voltage space vectors, is replaced by two other voltage space vectors. In the case of low degrees of modulation, for example below 0.6, and in the case of high phase currents, depending on the modulation index, for example, that zero voltage space vector that is produced only by the neutral point switching apparatuses is at least partially replaced by the voltage space vector that is produced only with the high-side switching apparatuses being involved, and/or by the voltage space vector that is produced only with the low-side switching apparatuses being involved.

In the case of certain degrees of modulation, in particular in the case of degrees of modulation of around 0.6 and high phase currents, one of the redundant, inner, shorter voltage space vectors is replaced by two replacement voltage space vectors that are adjacent in the space vector diagram, that is to say one basic voltage space vector and one zero voltage space vector, by virtue of these replacement voltage space vectors being provided alternately and with an equal temporal weighting. Therefore, the neutral point switches may be easily relieved of load if necessary.

Provision may also be made for a temporal weighting of the redundant voltage vectors to be determined within the switching pattern in such a way that a deviation in a neutral point voltage is reduced. This embodiment is based on the finding that switching states with the neutral point switching apparatuses involved cause a current load at the neutral point connection, which, if it is not compensated for over the modulation period, may cause an undesired deviation in the neutral point voltage. This deviation may be achieved by way of the temporal weighting of the redundant voltage vectors in the switching pattern and in the conduction-loss-reducing variant thereof. If two voltage vector pairs comprising redundant voltage vectors are involved when modulating the output voltage, that voltage vector pair in which the redundant voltage vector that has a higher temporal weighting has a lower number of switching states with neutral point switch involvement is primarily used for neutral point balancing. Therefore, the change in the neutral point voltage and the loading of the neutral point switching apparatuses may be reduced at the same time.

The embodiments presented with reference to the method according to the invention and the advantages of these embodiments correspondingly apply to the control apparatus according to the invention, to the power electronics module according to the invention and to the motor vehicle according to the invention.

Further features of the invention emerge from the claims, the figures and the description of the figures. The features and combinations of features mentioned above in the description and the features and combinations of features mentioned below in the description of the figures and/or shown in the figures alone may be used not only in the respectively indicated combination, but also in other combinations or on their own.

The invention will now be explained in more detail using a preferred exemplary embodiment and with reference to the drawings, in which:

### BRIEF DESCRIPTION OF THE DRAWINGS

FIG. 1 shows a circuit diagram of one configuration of a 3-level inverter;

FIG. 2 shows an illustration of a vector diagram of the 3-level inverter;

FIG. 3 shows an illustration of a switching pattern for modulating an output voltage;

FIG. 4 shows an illustration of time periods of different voltage vectors within the switching pattern; and

FIG. 5 shows an illustration of conduction-loss-reducing switching pattern variants for modulating an output voltage of the 3-level inverter.

### DETAILED DESCRIPTION OF THE DRAWINGS

Identical elements and elements with the same function are provided with the same reference signs in the figures.

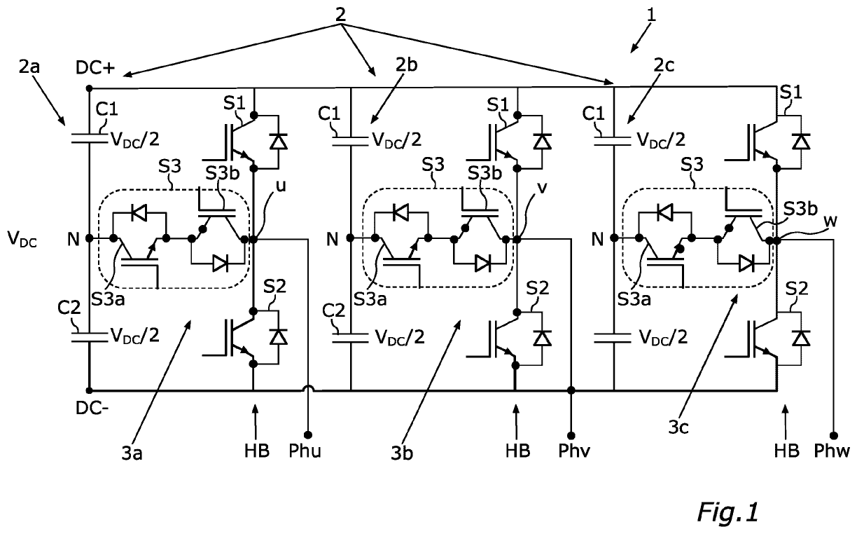

FIG. 1 shows a 3-level inverter 1 for an electrified motor vehicle. On the input side, the 3-level inverter 1 has an intermediate circuit 2 that in this case has three intermediate circuit branches 2a, 2b, 2c, each comprising a series circuit comprising two capacitors C1, C2. A high-side connection DC+ and a low-side connection DC− of the intermediate circuit 2 are connected to poles of an electrical energy storage unit of the motor vehicle, which energy storage unit provides a DC voltage V_{DC} to the intermediate circuit 2. Here, half the DC voltage V_{DC}/2 is applied to each capacitor C1, C2. The 3-level inverter 1 also has three switching sections 3a, 3b, 3c, which are electrically connected to in each case one of the intermediate circuit branches 2a, 2b, 2c here. However, provision may also be made for the intermediate circuit 2 to have only one intermediate circuit branch comprising two capacitors C1, C2 interconnected in series, the switching sections 3a, 3b, 3c being connected to this one intermediate circuit branch. Each switching section 3a, 3b, 3c has a phase tap u, v, w that is connected to a phase Phu, Phv, Phw of an electrical drive machine of the motor vehicle.

Each switching section has three switching apparatuses S1, S2, S3 that may each have at least one switch, which is in the form of a semiconductor switch, for example IGBTs. The switching apparatuses S1 and S2 are interconnected to form a half-bridge HB of the respective switching section 3a, 3b, 3c. The first switching apparatuses S1 are high-side switching apparatuses and are connected to the high-side connection DC+ of the intermediate circuit 2, which high-side connection is connected to a positive pole of the electrical energy storage unit, and to a tap A of the respective half-bridge HB. The second switching apparatuses S2 are low-side switching apparatuses and are connected to the tap of the respective half-bridge HB and to the low-side connection DC− of the intermediate circuit 2, which low-side connection is connected to a negative pole of the electrical energy storage unit. The third switching apparatuses S3 are neutral point switching apparatuses and are connected to the tap and to a neutral point connection N of the respective intermediate circuit branch 2a, 2b, 2c between the two capacitors C1, C2. The neutral point switching apparatuses S3 each have two antiseries-interconnected neutral point switches S3a, S3b here.

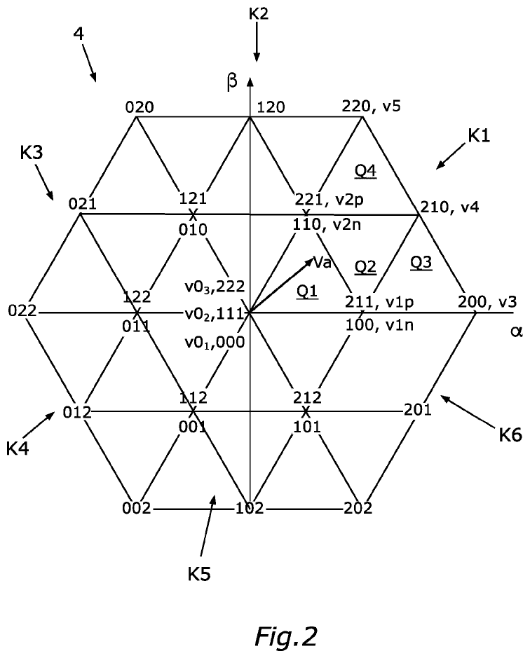

The 3-level inverter 1 may assume 27 switching states, by means of which a desired, operating-point-specific output voltage for application to the phases Phu, Phv, Phw is able to be modulated. In this case, each switching state produces a voltage vector, which may be illustrated in a space vector diagram 4 that is shown in FIG. 2 and has the axes α, β. In the space vector diagram 4, the different switching states (u, v, w), where u, v, w=0, 1, 2, with u identifying which of the switching apparatuses S1, S2, S3 in the first switching section 3a is closed, v identifying which of the switching apparatuses S1, S2, S3 in the second switching section 3b is closed, and w identifying which of the switching apparatuses S1, S2, S3 in the third switching section 3c is closed, are depicted at discrete points. “0” indicates that the respective low-side switching apparatus S2 is closed and therefore connects the respective phase tap u, v, w to the low-side connection DC−. “1” indicates that the respective neutral point switching apparatus S3 is closed and therefore connects the respective phase tap u, v, w to the neutral point connection N. “2” indicates that the respective high-side switching apparatus S1 is closed and therefore connects the respective phase tap u, v, w to the high-side connection DC+. Here, the discrete points mark an arrow tip of a voltage space vector that is produced by the respective switching state and has a certain length and a certain phase angle. It is already clear here that switching states that produce identical voltage vectors exist. By way of example, the switching states “221” and “110” produce identical voltage vectors. The switching states “000”, “111” and “222” also produce identical voltage vectors, specifically a zero voltage vector v0₁, v0₂, v0₃ in each case.

The space vector diagram is divided into six sectors K1, K2, K3, K4, K5, K6, wherein each sector K1, . . . , K6 is divided into four segments Q1, Q2, Q3, Q4 (shown only for the first sector K1 here). If a certain, operating-point-specific output voltage, for example the output voltage vector Va shown in FIG. 2, is intended to be modulated, the sector K1, . . . , K6 and the segment Q1, . . . , Q4 of the respective sector K1, . . . , K6 in which the respective output voltage vector Vₐ is situated are initially determined. By way of example, the output voltage vector Vₐ is situated in the first sector K1 in the first segment Q1 and is therefore able to be modulated or approximated by those voltage vectors v0₁, produced by switching state “000”, v0₂, produced by switching state “111”, v0₃, produced by switching state “222”, v2p, produced by switching state “221”, v2n, produced by switching state “110”, v1p, produced by switching state “211”, and v1n, produced by switching state “100”, that form vertices of the first segment Q1 and therefore surround the output voltage vector Vₐ to be produced.

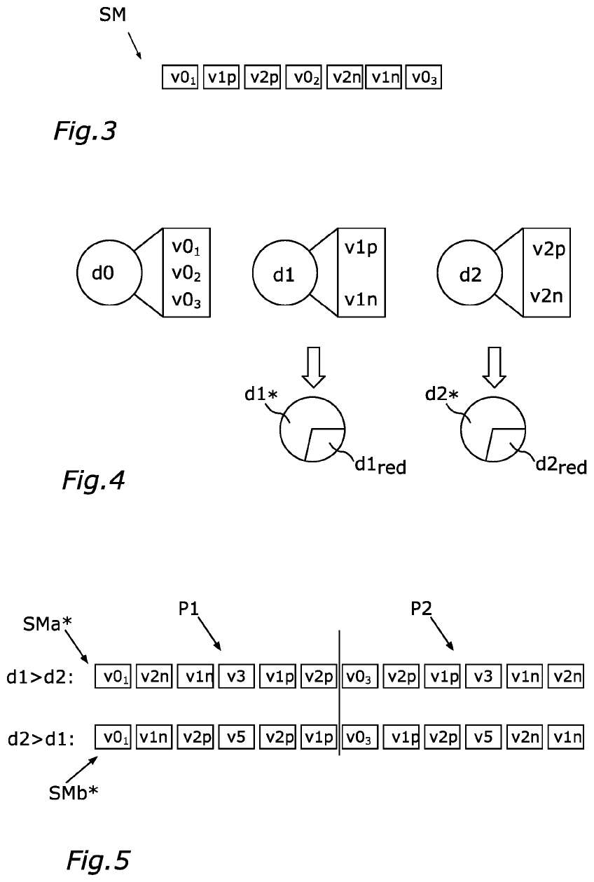

In the case of low degrees of modulation of the 3-level inverter 1, in particular if the degree of modulation falls below a predefined threshold value, for example 0.6, during the symmetrical space vector modulation, the inner, short voltage vectors v1p, v1n, v2p, v2n and the zero voltage vectors v0₁, v0₂, v0₃ are alternated within a switching pattern in order to achieve even loading of the switching apparatuses. By way of example, the switching pattern SM shown in FIG. 3 may be predetermined. FIG. 4 shows the total durations d0 of the zero voltage vectors v0₁, v0₂, v0₃, d1 of the voltage vectors v1p and v1n, and d2 of the voltage vectors v2p and v2n within the switching pattern SM. The individual durations of the zero voltage vectors v0₁, v0₂, v0₃ within the total duration d0 may be chosen to be of equal length. Depending on the modulation index and the phase current, however, a proportion of the zero voltage vector v0₂ may be reduced and divided between the other two zero voltage vectors v0₁, v0₃.

In particular, the voltage vectors v1p, v1n, v2p, v2n influence a neutral point voltage at the neutral point connection N of the intermediate circuit 2 since these voltage vectors v0₁, v1p, v1n, v2p, v2n are produced with at least one neutral point switching apparatus S3 being involved and therefore at least one of the phase taps u, v, w is electrically connected to the neutral point connection N. The more phase taps u, v, w are connected to the neutral point connection N for each switching state, that is to say the more neutral point switching apparatuses S3 are involved in a switching state, the greater the undesired influence on the neutral point voltage is. Therefore, in sector K1, either the voltage vector v1n may have a proportionally higher weighting than the voltage vector v1p or the voltage vector v2n may have a higher weighting than the voltage vector v2p. Since, when being produced, the voltage vector v1n is connected to the neutral point connection N only via a phase tap u, whereas the voltage vector v2n is connected to the neutral point connection N via the two phase taps u, v, the neutral point voltage is balanced by way of the proportionally higher weighting of the voltage vector v1n in order to relieve the neutral point switching apparatuses S3 of load.

In the case of high degrees of modulation, for example in the case of degrees of modulation of around 0.6 and high phase currents, the neutral point switching apparatuses S3 in particular have high conduction losses. Therefore, the durations d1 and d2 of the redundant voltage vectors v1p, v1n and v2p, v2n are reduced at least by the durations d1_{red} and d2_{red}, with the result that the voltage vectors v1p, v1n and v2p, v2n only occur in the switching pattern for the durations d1* and d2*. In order to achieve this duration reduction d1_{red} and d2_{red}, a conduction-loss-reducing variant SMa* (for d1>d2) or SMb* (for d2>d1) of the switching pattern SM is determined. FIG. 5 shows the conduction-loss-reducing variants SMa*, SMb* for two successive modulation periods P1, P2. For d1>d2, the vectors v1p, v1n in the variant SMa* are replaced by the adjacent voltage vectors v0₁ and v3 or v0₃ and v3 by a configurable proportion. For d2>d1, the vectors v2p, v2n in the variant SMb* are replaced by the adjacent voltage vectors v0₁ and v5 or v0₃ and v5 by a configurable proportion. These voltage vectors v0₁, v0₃, v3 and v5 do not have the neutral point switching apparatuses S3 involved, but may depict the voltage vectors v1p, v1n or v2p, v2n situated therebetween in the space vector diagram. Here, the temporal weighting in particular of that voltage vector v2n, v1p whose switching state has the greatest proportion of neutral point switching apparatuses S3 may be reduced. Furthermore, in the first modulation period P1, the zero vector v0₁ may be set in each case, and in the second modulation period P2, the zero vector v0₃ may be set in each case. The load is therefore evenly divided between the high-side switching apparatus S1 and the low-side switching apparatus S2.

1-10. (canceled)

11. A method for operating a 3-level inverter to reduce conduction losses of neutral point switching apparatuses, wherein the 3-level inverter comprises:
an intermediate circuit that includes: a high-side connection, a low-side connection, and a neutral point connection; and
at least three switching sections connected to the intermediate circuit, wherein each switching section has: a phase tap electrically connecting to a respective phase of an electrical drive machine; and three switching apparatuses in the form of: a high-side switching apparatus connected to the high-side connection, a low-side switching apparatus connected to the low-side connection, and a neutral point switching apparatus connected to the neutral point connection, wherein a switching pattern for the switching apparatuses is determined so as to modulate an operating-point-specific output voltage, and wherein, by way of the switching pattern, the switching apparatuses are transferred to different switching states so as to connect the phase tap of the respective switching section to a respective one of the connections of the intermediate circuit and thereby generate a voltage vector, and wherein the method comprises:
predetermining the switching pattern in a conduction-loss-reducing variant in which at least one voltage vector of the switching pattern, which is produced by a switching state with at least one neutral point switching apparatus involved, is at least partially replaced by two voltage vectors that are produced by switching states without the neutral point switching apparatuses involved.

12. The method of claim 11, wherein the conduction-reducing variant of the switching pattern is provided depending on a modulation index and/or a degree of modulation and/or a phase current and/or a temperature of the neutral point switching apparatuses.

13. The method of claim 12, wherein, depending on the modulation index and the phase current for the conduction-reducing variant of the switching pattern, a zero voltage vector, which is produced by a switching state with the neutral point switching apparatuses involved, is at least partially replaced by zero voltage vectors, which are produced by switching states without the neutral point switching apparatuses involved.

14. The method of claim 12,
wherein, depending on the degree of modulation and the phase current for the conduction-loss-reducing variant of the switching pattern, at least one of two voltage vectors, which are produced in a redundant manner by way of different switching states with the neutral point switching apparatuses involved, is at least partially replaced by a zero voltage vector and a basic voltage vector adjacent to the redundant voltage vector, and
wherein the zero voltage vector and the basic voltage vector are produced without the neutral point switching apparatuses involved.

15. The method of claim 14, wherein at least that one of the redundant voltage vectors whose switching state has the highest proportion of neutral point switching apparatuses is at least partially replaced by the zero voltage vector and the basic voltage vector.

16. The method according of claim 11, wherein a temporal weighting of voltage vectors that are produced in a redundant manner by way of different switching states of the switching apparatuses is determined within the switching pattern in such a way that a deviation in a neutral point voltage over a modulation period is reduced.

17. The method according to claim 16, wherein, in the case of two voltage vector pairs that each comprise two redundant voltage vectors, the redundant voltage vector of that voltage vector pair whose switching state has a lower proportion of involved neutral point switching apparatuses has a higher temporal weighting when reducing the deviation in the neutral point voltage in order to reduce the conduction losses of the neutral point switching apparatuses.

18. A control apparatus for a power electronics module of a motor vehicle, wherein the control apparatus is configured to carry out the method of claim 11.

19. A power electronics module for a motor vehicle, comprising:
a 3-level inverter including:
an intermediate circuit having: a high-side connection, a low-side connection, and a neutral point connection; and
at least three switching sections connected to the intermediate circuit, wherein each switching section includes:
a phase tap electrically connecting to a respective phase of an electrical drive machine, and
three switching apparatuses in the form of: a high-side switching apparatus connected to the high-side connection, a low-side switching apparatus connected to the low-side connection, and a neutral point switching apparatus connected to the neutral point connection; and
a control apparatus according to claim 18.

20. A motor vehicle comprising:
an electrical energy storage unit;
an electrical drive machine; and
the power electronics module of claim 19,
wherein the 3-level inverter is connected on the input side to the electrical energy storage unit and on the output side to phases of the electrical drive machine.
